(19) United States
(12) Patent Application Publication
(10) Pub. No.: US 2005/0128035 A1
(43) Pub. Date: Jun. 16, 2005

(54) Electric actuator

(75) Inventors: Ryoichi Otaki, Kanagawa (JP); Daisaku Kawada, Kanagawa (JP); Hiroshi Suzuki, Kanagawa (JP); Hideki Hashitani, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD., Tokyo (JP)

(21) Appl. No.: 10/502,358

(22) PCT Filed: Jan. 8, 2003
(86) PCT No.: PCT/JP03/00080

(30) Foreign Application Priority Data
Jan. 25, 2002 (JP) 2002-16500
Feb. 5, 2002 (JP) 2002-28542

(51) Int. Cl. H01F 7/08

(52) U.S. Cl. 335/220

(57) ABSTRACT

A portion of an outer face 41a installed with a second electric motor 18b is recessed more than a portion of projecting a switch shaft 2a. By the constitution, an outer diameter D₁₈ of the shifting electric motor 18b is increased while ensuring a rigidity of a switch shaft 2a by restraining an amount of projecting the switch shaft 2a. Further, swift and firm gear change operation is made to be able to carry out by increasing an output of the shifting electric motor 18b.

### TECHNICAL FIELD

The present invention relates to an electric type actuator for a transmission.

### BACKGROUND ART

As a transmission for an automobile, there have been widely used a manual transmission in which a driver changes gears by operating a shift lever along with a clutch pedal and an automatic transmission in which a gear ratio is automatically changed in accordance with a driving situation. Further, there is known an automatic transmission there among combined with a torque converter and a planetary gear mechanism, combined with a variable type pulley and an endless belt or the like. Further, in recent years, there has been used a transmission for an automobile for automatically switching a gear change unit which has been used as a manual transmission in a background art and automatically connecting and disconnecting a clutch since operation thereof is easy and a transmission efficiency is higher than that of a general automatic transmission.

International Publication WO 01/31234 A1 discloses a structure for switching gears constituting a gear change unit in such a transmission for an automobile. An explanation will be given of an electric driving apparatus for a transmission according to the international publication in reference to FIGS. 18 through 24.

First, an explanation will be given of a first example shown in FIGS. 18 through 21. A transmission case 1 is a case including a gear change unit similar to that of a manual transmission. A front end portion 3 of a switch shaft 2 for switching a gear ratio of the gear change unit is projected from a side face of the transmission case 1. A middle portion of the front end portion 3 is formed with a male spline portion 4. The male spline portion 4 is engaged by a spline with a spline cylinder 5 formed with a female spline at an inner peripheral face thereof. A further end portion of the front end portion 3 projected from the spline cylinder 5 is coupled with an engaging claw 7 formed with an engaging groove 6 at an outer peripheral face thereof.

The switch shaft 2 is displaced in an axial direction (head and tail direction of FIG. 18, up and down direction of FIG. 19) in selecting operation and rotated in shifting operation. Here, the selecting operation is operation of displacing a shift lever in a width direction of a vehicle in a general manual type floor shift vehicle to thereby select a gear for changing speed. Meanwhile, the shifting operation is operation of displacing the shift lever in a front and rear direction of the vehicle to thereby couple a synchromesh mechanism in correspondence with the selected gear to make the gear capable of transmitting power.

A detailed explanation will be given of the selecting operation and the shifting operation as follows. Consider here a gear change unit realizing six kinds of gear change states of forward 5 stages (1 speed through 5 speed) and rearward 1 stage (R).

In the selecting operation, one of three kinds of both end positions in a left and right direction and a center position in the left and right direction of FIG. 22 is selected. In the selecting operation, the synchromesh mechanism is maintained in a free state and therefore, a neutral state is brought about and any gear change state is not brought about. In the shifting operation, the shift lever is displaced from any position of the three kinds brought into the neutral state in either direction (upper direction or lower direction of FIG. 22). Thereby, any synchromesh mechanism is brought into a connected state to bring about any gear change state. Here, according to International Publication WO 01/31234 A1, a selecting type actuator 8 which is a pivoting type actuator is provided between an outer face of the transmission case 1 and the engaging claw 7 to displace the switch shaft 2 in the axial direction in the selecting operation.

As shown by FIG. 20, the selecting actuator 8 includes a selecting electric motor 9 and a multistreak worm gear 10 driven to rotate by an output shaft of the selecting electric motor 9. The multistreak worm gear 10 is brought in mesh with a worm wheel 11. An output shaft 12 of the worm wheel 11 constituting a rotational center thereof is coupled to fix to a base end portion of a pivoting arm 13 and the pivoting arm 13 is rotated along with the worm wheel 11. An engaging projected portion 14 formed at one side face of a front end portion (an upper face of a left end portion of FIG. 18) of the pivoting arm 13 is engaged with an engaging groove 6 of an engaging claw 7 to thereby enable to displace the switch shaft 2 in the axial direction.

Meanwhile, a shifting actuator 16 for rotating the switch shaft 2 to carry out the shifting operation is provided between the outer face of the transmission case 1 and a front end portion of a driving arm 15 fixedly provided to an outer peripheral face of the spline cylinder 5. The shifting actuator 16 is fixedly supported by a shifting electric motor 18 capable of rotating regularly and reversely via a motor housing 19 in a shape of a stepped cylinder at one end portion (left end portion of FIG. 21) of a shifting case 17 substantially in a cylindrical shape.

A portion of a ball screw shaft 20 proximate to a base end portion thereof is rotatably supported by a rolling bearing 21 of a deep groove type ball bearing or the like (in a state of being hampered from being displaced in an axial direction) at inside of the motor housing 19. A portion of the base end portion of the ball screw shaft 20 projected from the rolling bearing 21 is coupled to an output shaft 22 of the shifting electric motor 18 to enable to transmit a rotational force.

A ball nut 23 is arranged at a surrounding of the ball screw shaft 20. A plurality of balls 26 are arranged between a male ball screw groove 24 formed at an outer peripheral face of the ball screw shaft 20 and a female ball screw groove 25 formed at an inner peripheral face of the ball nut 23 to constitute a ball screw apparatus 27. The ball nut 23 is displaced in an axial direction of the ball screw shaft 20 in accordance with rotation of the ball screw shaft 20 since the ball nut 23 is hampered from being rotated by itself as mentioned later. A base end portion of an output member 28 in a cylindrical shape is coupled to one end face (right end face of the drawing) of the ball nut 23.

A sliding bearing 29 locked by an inner peripheral face of a front end portion (right end portion of FIG. 21) of the shifting case 17 is brought into sliding contact with an outer peripheral face of a middle portion of the output member 28. Further, a front end portion of the output member 28 is coupled with a front end portion of the driving arm 15 via a coupling bracket 30 and a coupling pin 31 (FIG. 18 through FIG. 19). Further, an outer peripheral face of a middle portion of the output member 28 is formed with a guide groove 32 in an axial direction of the output member 28. The guide groove 32 is engaged with a guide pin 33 fixed to the front end portion of the shifting case 17 to prevent the output member 28 and the ball nut 23 from being rotated.

Further, there is provided a detent mechanism 34 engaged with the output member 28 at a middle position of a stroke of the ball nut 23 for producing a resistance against a displacement of the ball nut 23 in the axial direction between the output member 28 and the shifting case 17. In order to constitute the detent mechanism 34, a recess hole 35 in a conical shape is formed at an outer peripheral face of a middle portion of the output member 28 and a ball 37 is held at inside of a cylinder portion 36 provided at the shifting case 17 to be able to displace in a diameter direction of the shifting case 17. Further, the ball 37 is elastically pressed to an outer peripheral face of the output member 28 by a spring 38.

The electric driving apparatus for a transmission of the background art constituted as described above changes the gear of the gear change unit included in the transmission case 1 as follows. First, the selecting electric motor 9 constituting the selecting actuator 8 is rotated in a predetermined direction to thereby displace to pivot the pivoting arm 13 in an up and down direction of FIG. 19. Further, the switch shaft 2 is displaced in the axial direction in a predetermined direction via the engaging claw 7 by the engaging recess portion 14 provided at the front end portion of the pivoting arm 13 to thereby carry out the selecting operation.

After carrying out the selecting operation in this way, the switch shaft 2 is rotated in a predetermined direction via the driving arm 15 by extracting and retracting the shifting actuator 16 in order to carry out the shifting operation. When the shifting operation is carried out in this way, the ball screw shaft 20 is rotated in a predetermined direction by the shifting electric motor 18. Further, the ball nut 23 and the output member 28 are displaced in the axial direction by the ball screw apparatus 27 to push and pull the driving arm 15.

Next, FIGS. 23 through 24 show a second example of the background art according to the above-described international publication. In the case of the example, a driving bracket 140 is fixed to a portion of a front end portion (upper end portion of FIG. 24) of the switch shaft 2 rotatably supported on an inner side of a supporting plate 139 fixed to an opening portion of the transmission case 1 which is projected from the transmission case 1. Further, the engaging projected portion 14 provided at the front end portion of the pivoting arm 13 of the selecting actuator 8 (refer to FIGS. 18 through 20) is engaged with an engaging groove 6a formed on one face of the driving bracket 140. Further, a sliding pin 141 is supported between front end portions of a pair of driving arms 15a, 15a formed at both end portions in an axial direction of other side of the portion of the outer peripheral face of the driving bracket 140 in parallel with the switch shaft 2. Further, the sliding pin 141 is inserted into a circular hole 142 formed at a front end portion of the output member 28a of the shifting actuator 16 (refer to FIGS. 18, 20 and 22).

Also in the case of the second example constituted as described above, similar to the above-described case of the first example, the selecting operation can be carried out by displacing the switch shaft 2 in the axial direction by pivoting the pivoting arm 13. Further, the shifting operation can be carried out by displacing the output member 28a in the axial direction.

However, when the above-described electric driving apparatus for a transmission is reduced into practice, it is necessary in view of carrying out swift gear change operation to increase an output of the shifting electric motor 18 constituting the shifting actuator 16. That is, in the above-described selecting operation and switching operation, a force required for the selecting operation is small, however, a force required for the shifting operation is large and therefore, it is necessary to swiftly and firmly carry out the shifting operation. For that purpose, it is necessary to use the shifting electric motor 18 having a large output (torque×rotational speed). Here, in order to firmly carry out the shifting operation by using a motor having a small output, it is necessary to ensure a force of pushing and pulling the output shaft member 28 by increasing a speed reduction ratio of the ball screw mechanism 28, however, in that case, a speed of moving the output shaft member 28 is retarded and shift shifting operation cannot be carried out.

However, in the case of the structure of the background art, it is difficult to use the shifting electric motor 18 having the large output. An explanation will be given in this regard in reference to FIGS. 25 and 26 showing an electric actuator. FIGS. 25 and 26 show a structure in which a shifting actuator 16a is attached to an outer face of a transmission case 1a containing a gear change unit constituting a driven portion at inside thereof and a switch shaft 2a projected from an outer face of the transmission case 1a is made to be able to drive to rotate by the shifting actuator 16a. In the case of the example, a driving arm 15a is provided at an outer peripheral face of a spline cylinder 5a engaged by spline with an outer peripheral face of the switch shaft 2a, and a long hole 39 prolonged in a diameter direction of the switch shaft 2a is formed at a middle portion of the driving arm 15a. Further, the long hole 38 is coupled with a coupling pin 31a supported by a front end portion of an output shaft member 28a of the shifting actuator 16a. According to the constitution, the switch shaft 2a is displaced in a rotational direction based on displacement of the output shaft member 28a in an axial direction. Therefore, it is not necessary to pivot to displace a center shaft of the output shaft member 28a as in the structure of the background art shown in FIGS. 18 and 19 and the shifting actuator 16a is fixed to the outer face of the transmission case 1a by an attaching flange 40.

In the case of the structure shown in FIGS. 25 and 26, a center axis α of the shifting actuator 16a is in parallel with the outer face of the transmission case 1a. Therefore, an outer diameter d₁₈ of a shifting electric motor 18a constituting the shifting actuator 16a is restricted by a distance L₅ between the outer face of the transmission case 1a and a center of the spline cylinder 5a. Specifically, the outer diameter d₁₈ of the shifting electric motor 18a is to be twice as much as or smaller than the distance L₅ (d₁₈≦2 L₅). Further, the distance L₅ cannot be increased so much since it is necessary to ensure bending rigidity of the switch shaft 2a and prevent a damage of crack, bending or the like from being brought about at the switch shaft 2a. Therefore, the outer diameter d₁₈ of the shifting electric motor 18a cannot be increased according to the structure shown in FIGS. 25, 26.

On the other hand, in order to increase the output of the shifting electric motor 18a to carry out swift gear change operation, it is effective to increase the outer diameter d₁₈ of the shifting electric motor 18a. It is desired to realize a structure to be able to increase an outer diameter of a shifting electric motor constituting a shifting actuator while ensuring the bending rigidity of the switch shaft 2a in consideration of these facts. In the case of the electric driving apparatus for the transmission according to the international publication, shown in FIG. 19, the switch shaft 2 is supported by an inner diameter side of the bracket in the cylindrical shape fixed to the outer face of the transmission case 1 and therefore, it is possible in one respect to increase a diameter of the selecting electric motor 9 while ensuring the rigidity of the switch shaft 2. However, according to the invention of the electric driving apparatus for a transmission according to the above-described international publication, a consideration is given to supporting the selecting actuator 8 by the transmission case 1 to be able to displace to pivot and a consideration is not given to increasing the diameter of the selecting electric motor 9. Further, integrating operation is complicated by providing the above-described bracket.

### DISCLOSURE OF THE INVENTION

It is an object of the invention to provide an electric type actuator capable of swiftly and firmly carrying out shifting operation in view of the above-described problem.

An electric type actuator of the invention is an electric type actuator fixed to an outer face of a case containing a driven portion at inside thereof for driving a transmitting member projected from the outer face for driving the driven portion, the electric type actuator including:
an electric motor; and
an output member for transmitting a displacement based on rotation of the electric motor to the transmitting member;
wherein a radius of the electric motor is larger than a distance from an axis center of the output member disposed at an axis center portion of the transmitting member to the outer face of the case.

Further, the outer face of the case of provided with a recess portion and a portion of a housing of the electric motor is made to advance into the recess portion.

Further, the outer face of the case is an inclined face formed with a portion of projecting the transmitting member and a portion of attaching a housing of the electric motor continuously to each other.

Further, the electric type actuator includes an actuator case, a ball screw shaft provided at inside of the actuator case, and a ball nut reciprocated along the ball crew shaft, an inner peripheral face of the actuator case is provided with a stopper for preventing an end face in an axial direction of the ball nut from being butted to a portion fixed to the ball screw shaft.

According to the electric type actuator of the invention constituted as described above, the output of the electric motor can be increased by increasing the outer diameter of the electric motor while ensuring the rigidity of the transmitting member without excessively increasing the amount of projecting the transmitting member from the outer face of the case. Therefore, when the electric type actuator is integrated, for example, an electric driving apparatus for a transmission, gear change operation can swiftly and firmly be carried out.

### BRIEF DESCRIPTION OF THE DRAWINGS

FIG. 1 is a side view showing a first embodiment of the invention.

FIG. 2 is a side view showing a modified example of the first embodiment of the invention.

FIG. 3 is an outline plane view showing a total constitution of a second embodiment of the invention.

FIG. 4 is a front view of a selecting actuator.

FIG. 5 is a plane view of the selecting actuator.

FIG. 6 is a rear view of the selecting actuator.

FIG. 7 is a left side view of the selecting actuator.

FIG. 8 is a sectional view taken along a line A-A of FIG. 4.

FIG. 9 is a plane view of a shifting actuator.

FIG. 10 is a front view of the shifting actuator.

FIG. 11 is a right side view of the shifting actuator.

FIG. 12 is a sectional view taken along a line B-B of FIG. 8.

FIG. 13 is a view enlarging a central portion of FIG. 12 showing a state of moving a ball nut to an end portion.

FIG. 14 is a front view showing a state of connecting the shifting actuator and a driving arm.

FIG. 15 is a sectional view taken along a line C-C of FIG. 14.

FIG. 16 is a sectional view showing other example of a detent structure of a ball nut.

FIG. 17 is a plane view showing an example of a structure of integrating a selecting actuator and a shifting actuator.

FIG. 18 is a plane view showing a first example of an electric driving apparatus for a transmission of a background art.

FIG. 19 is a sectional view taken along a line D-D of FIG. 18.

FIG. 20 is a sectional view taken along a line E-E of the same.

FIG. 21 is a sectional view taken along a line F-F of the same.

FIG. 22 is an outline plane view showing an example of a shift pattern of a transmission.

FIG. 23 is a partial plane view showing a second example of an electric driving apparatus for a transmission of a background art.

FIG. 24 is a sectional view taken along a line G-G of FIG. 23.

FIG. 25 is a plane view showing an example of an electric actuator of a background art.

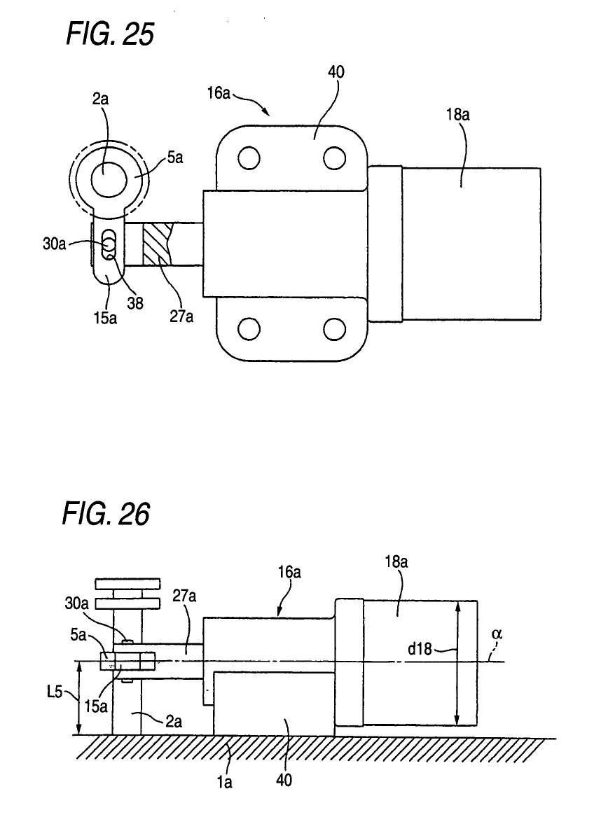

FIG. 16 is a side view of the electric actuator of FIG. 25.

### BEST MODE FOR CARRYING OUT THE INVENTION

An explanation will be given in details of Embodiments of the invention in reference to the drawings as follows.

(First Embodiment)

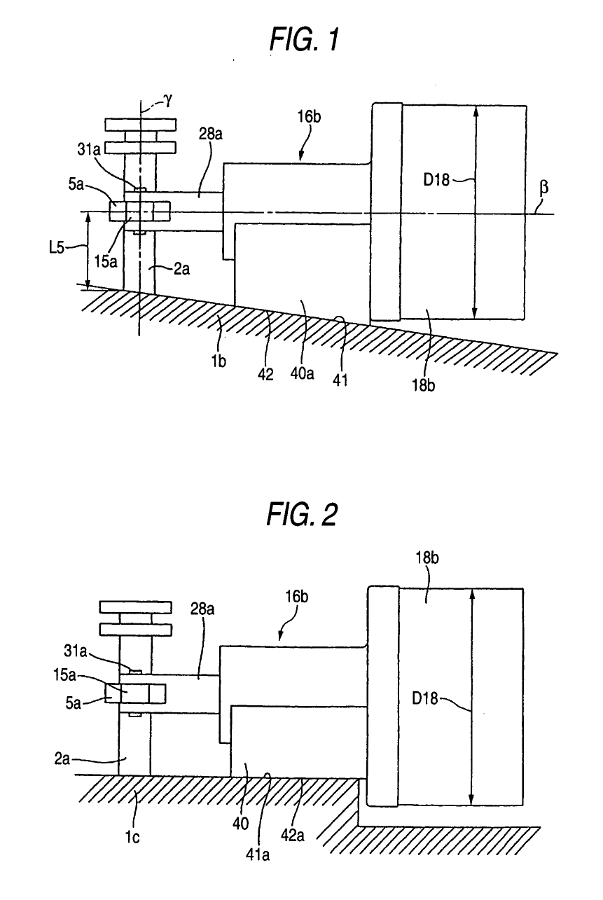

An explanation will be given of an electric actuator according to First Embodiment of the invention as follows. FIG. 1 shows a case of applying to attach a shifting actuator 16b integrated to an electric driving apparatus for a transmission for carrying out shifting operation to an outer face of a transmission case 1b according to First Embodiment of the invention. According to the embodiment, the shifting actuator 16b is attached to an outer face 41 of the transmission case 1b containing a gear change unit which is a driven portion at inside thereof. The shifting actuator 16b is made to be able to drive to rotate a switch shaft 2a projected from the outer face of the transmission case 1b per se (a portion integrated with the transmission case 1b). Also in the case of the embodiment, similar to the structure shown in FIGS. 25 and 26, the driving arm 15a is provided at the outer peripheral face of the spline cylinder 5a engaged with the outer peripheral face of the switch shaft 2a by a spline and the middle portion of the driving arm 15a is formed with a long hole 39 (refer to FIG. 25) prolonged in the diameter direction of the switch shaft 2a. Further, the long hole 39 is engaged with a coupling pin 31a supported by a front end portion of an output shaft member 28a of the shifting actuator 16b.

According to the embodiment, the shifting actuator 16b is fixed to the outer face 41 of the transmission case 1b by an attaching flange 39a. The shifting actuator 16b is provided in a state of being inclined to the outer face 41. In other words, a center axis β of the shifting actuator 16b and the outer face 41 are not in parallel with each other. Further, the switch shaft is projected from the outer face 41 in an inclined state. Further, the center axis β of the shifting actuator 16b is present on an imaginary plane orthogonal to a center axis γ of the switch shaft 2a. Therefore, a butting face 42 of the attaching flange 40a brought into contact with the outer face 41 is inclined in accordance with inclination of the center shaft γ of the switch shaft 2a relative to the outer face 41. Further, inside of a portion of a middle portion of the shifting actuator 16b installed with the attaching flange 40a contains the ball screw mechanism 27 (refer to FIG. 21) for converting a rotational movement of the shifting electric motor 18b, mentioned later, into linear movement to transmit to the output shaft member 28a.

In the case of the embodiment, the outer diameter D₁₈ of the shifting electric motor 18b constituting the shifting actuator 16b can be made to be larger than twice of the distance between the outer face 41 of the transmission case 1b and the center of the spline cylinder 5a (distance from an axis center of the output shaft member 28 to the outer face 41 at an axis center portion of the switch shaft 2a) L₅ (D₁₈>2 L₅). That is, the output of the shifting electric motor 18b can be increased by increasing the outer diameter D₁₈ of the shifting electric motor 18b while ensuring rigidity of the switch shaft 2a without excessively increasing an amount of projecting the switch shaft 2a from the outer face 41 of the transmission case 1b. Therefore, when integrated to, for example, an electric driving apparatus for a transmission, gear change operation can swiftly and firmly be carried out. These effects can be achieved by utilizing the transmission case 1b of the prior art as it is depending on a shape of the outer face of the transmission case 1b.

Next, FIG. 2 shows a modified example of Embodiment 1 of the invention. In the case of the example, by constituting an outer face 41a of a transmission case 1c by a stepped shape, the outer diameter D₁₈ of the shifting electric motor 18b constituting the shifting actuator 16b is increased without excessively increasing an amount of projecting the switch shaft 2a from the outer face 41a. That is, a portion of installing the shifting electric motor 18b is recessed in comparison with a portion of the outer face 41a of the transmission case 1c projecting the switch shaft 2a and to be brought into contact with a butting face 42a of an attaching flange 40. Further, the outer diameter D₁₈ of the shifting electric motor 18b is increased by an amount of recessing the portion. In accordance therewith, in the case of the example, the butting face 42a of the attaching flange 40 is not inclined as in the above-described first example.

Constitutions and operation of other portions are similar to those of First Embodiment and therefore, equivalent portions are attached with the same notations and a duplicated explanation thereof will be omitted.

(Second Embodiment)

An explanation will be given of Second Embodiment of the invention as follows. An electric driving apparatus for a transmission according to the embodiment is applicable to the electric driving apparatus for a transmission according to Embodiment 1. An explanation will be given in details in reference to the drawings as follows.

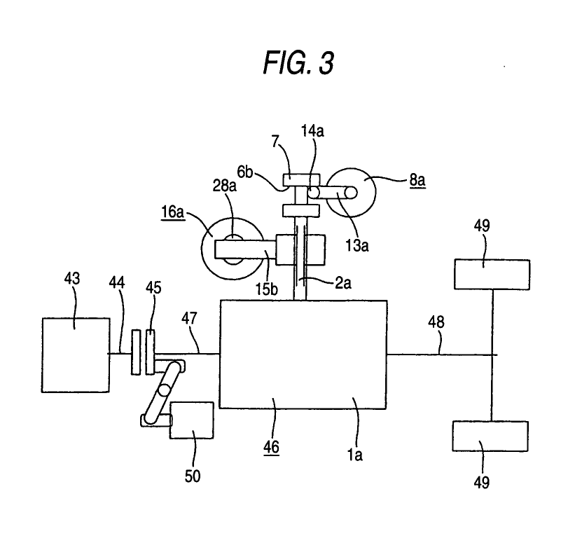

FIG. 3 shows a transmission apparatus for an automobile integrated with the electric driving apparatus of a transmission according to Second Embodiment of the invention. Rotation of a crankshaft 44 of an engine 43 is transmitted to an input shaft 47 of a gear change unit 46 via a clutch apparatus 45. Further, an output of the gear change unit 46 is transmitted to drive wheels 49, 49 via a propeller shaft 48. In the case of a structure shown in FIG. 3, the clutch apparatus 45 is a dry type single plate clutch combined with a general manual transmission and is connected and disconnected by a clutch actuator 50 of a hydraulic type or an electric type.

A gear ratio of the gear change unit 46 is changed by the electric driving apparatus for a transmission constituting an object of the invention. The switch shaft 2a projected from an outer face of a transmission case 1a containing the speed change unit 46 is driven freely by a selecting actuator 8a and a shifting actuator 16a. The selecting actuator 8a in the actuators displaces the switch shaft 2a in an axial direction (up and down direction of FIG. 3). Meanwhile, the shifting actuator 16a rotates the switch shaft 2a in a twisting direction.

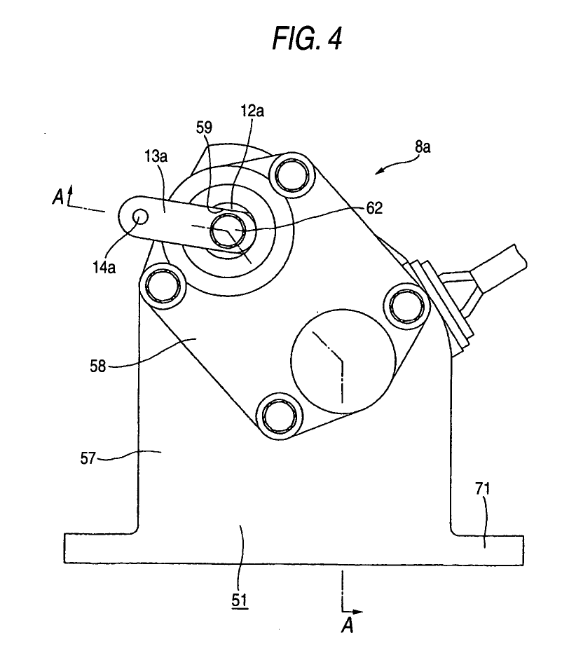

The selecting actuator 8a is constituted as shown by FIGS. 4 through 8. The selecting actuator 8a is constituted by integrating a selecting electric motor 9a, a pinion gear 52, an output shaft 12a, and a displacement sensor 53 which is a position sensor to a selecting case 51. The pinion gear 52 is formed at an outer peripheral face of a middle portion of a transmitting shaft 55 integrally with the transmitting shaft 55. The transmitting shaft 55 is rotatably supported by a pair of ball bearings at inside of the selecting case 51 in a state of being arranged concentrically with a rotating drive shaft 54 of the selecting electric motor 9a. A front end portion of the rotating drive shaft 54 and a base end portion of the transmitting shaft 55 are engaged with each other by serration engagement (including spline engagement) to thereby transmit rotation of the rotating drive shaft 54 to the transmitting shaft 55. By the constitution, a rotation transmitting portion having inconsiderable rattling can be provided at low cost. Further, male and female of the serration engagement in this case may be reversed from those in the illustrated case.

The selecting electric motor 9a is coupled to fix to one side face of a main body 57 constituting the selecting case 51 by bolts 65, 65 inserted through an attaching flange 64. Under the state, a front end portion of the selecting electric motor 9a is fit into a recess hole 66 formed at one side face of the main body 57 without play. An O ring 67 is locked by the front end portion of the selecting electric motor 91 to seal a fit portion. By the constitution, a foreign matter of rain water or the like is prevented from invading the selecting case 51 installed with the transmitting shaft 55 and the like and grease sealed in the selecting case 51 is prevented from being leaked.

The output shaft 12a is rotatably supported similarly by a pair of ball bearings at inside of the selecting case 51 in a state of being arranged in parallel with the transmitting shaft 55. A sector gear (fan-like gear) 56 is provided at an outer peripheral face of a middle portion of the output shaft 12a integrally with the output shaft 12a. The sector gear 56 and the pinion gear 52 are brought in mesh with each other to be able to drive to rotate the output shaft 12a in two directions by an amount of a predetermined angle. By the constitution, there is compactly realized a structure capable of driving the output shaft 12a by the amount of the predetermined angle by a torque needed for selecting operation. In order to be able to contain the sector gear 56 and the pinion gear 52 at inside of the selecting case 51, the selecting case 51 is constituted by attaching a cover 58 to the main body 57. By constituting the grease sealed into the selecting case 51 by kinds the same as each other at the respective ball bearings and the two gears 52 and 56, a deterioration accompanied by mixing grease used for lubrication of respective portions is prevented and low cost formation is achieved by simplifying control and filling operation of grease.

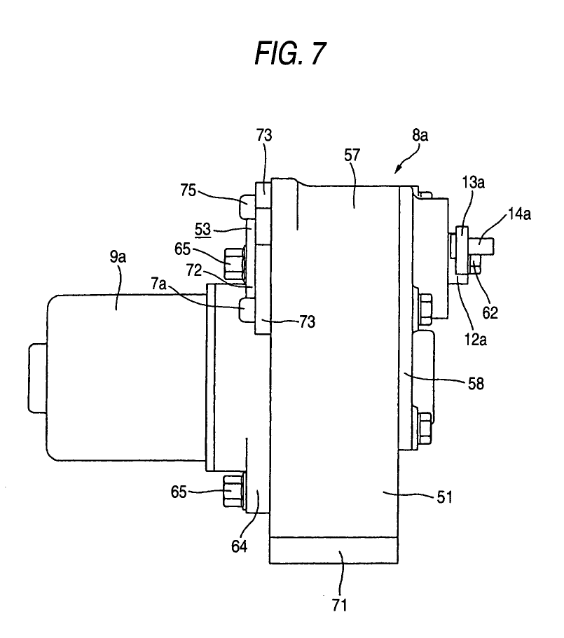

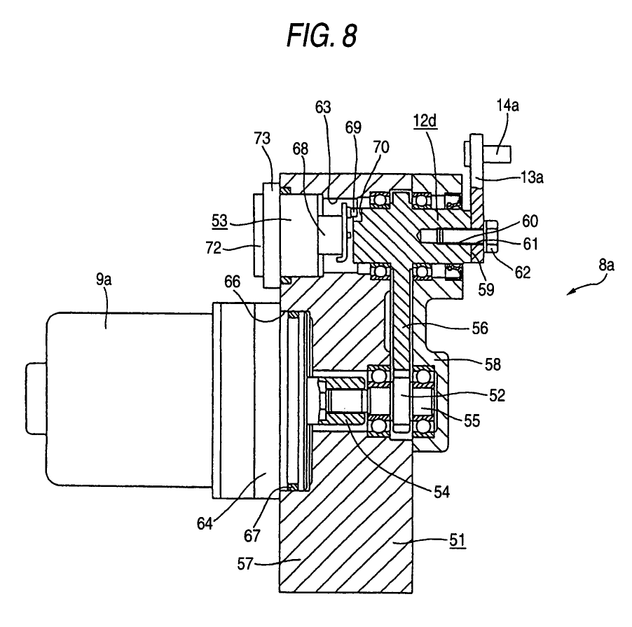

A front end face (right end face of FIG. 8) of the output shaft 12a is formed with a recess portion 59 in a diameter direction of the front face. A portion of a center portion of the front face of the output shaft 12a disposed at the recess portion 59 is formed with a screw hole 60 to fit a base end portion of the pivoting arm 13a into the recess portion 59 without play. Further, a coupling screw 62 inserted through a through hole 61 formed at a base end portion of the pivoting arm 13a is screwed to the screw hole 60 to fasten. Under the state, the base end portion of the pivoting arm 13a is coupled to fix to the front end portion of the output shaft 12a and is made to be rotatable along with the output shaft 12a. There is constituted an engaging projected portion 14a fit to fix with a pin and engageable with the engaging claw 7 (refer to FIG. 3) fixed to the switch shaft 2a at a front end portion of the pivoting arm 13a. A front half portion (right half portion of FIGS. 7 through 8) to constitute the engaging projected portion 14a is subjected to a high frequency heat treatment and an outer peripheral face of the engaging projected portion 14a is quenched to harden. By the treatments, there is restrained wear of the outer peripheral face of the engaging projected portion 10a accompanied by engaging the engaging claw 7 fixed to the end portion of the switch shaft 2a with an engaging groove 6b (refer to FIG. 3).

The displacement sensor 53 is supported by the selecting case 51 concentrically with the output shaft 12a. Therefore, an attaching hole 63 formed at the front end portion of the main body 57 for mounting the output shaft 12a is opened to two side faces of the main body 57. An engaging projection 69 projected at a detecting portion 68 of the displacement sensor 53 is engaged with an engaging recess portion 70 to transmit rotation of the output shaft 12a to the detecting portion 68. The displacement sensor 53 is like a potentiometer changing an electric property thereof of a resistance value or the like in accordance with an rotational angle of the detecting portion 68 to detect a pivoting angle of the output shaft 12a based on a measured value thereof.

Further, a structure of fixing the pin to constitute the engaging projected portion 14a to the front end portion of the pivoting arm 13a can be constituted by calking other than press-fitting, screwing or the like. Even in the case of constituting the structure by calking, a portion of the pin quenched to harden by the high frequency heat treatment is disposed only at the outer peripheral face of the front half portion of the engaging projected portion 14a and therefore, calking operation can easily be carried out. The base end portion of the pin is inserted into the attaching hole formed at the front end portion of the pivoting arm 13a when fixed by calking. Further, a flange portion in a shape of an outward flange formed at the middle portion in the axial direction of the pin or one face of the stopper ring stopped by the middle portion in the axial direction is butted to one face of the locking arm 13a (right face of FIGS. 7 through 8). Further, a portion of an end face of the pin projected from other face (left face of FIGS. 7 through 8) of the pivoting arm 13a is calked to widen outwardly in the diameter direction and the front end portion of the pivoting arm 13a is pinched between the portion and the flange portion or the stopper ring. The base end portion of the pin stays to be untreated without being quenched to harden and therefore, the calking and widening operation can easily be carried out.

The selecting actuator 8a having the above-described constitution is coupled to fix to the outer face of the transmission case 1a (refer to FIG. 3) by an attaching bolt, (not illustrated) inserted through an attaching flange 71 fixedly provided at a base end portion of the main body 57 of the selecting case 51. Among the respective members mounted to the selecting case 51, the selecting electric motor 9a having a large weight is attached proximately to the base end of the main body 57, that is, a portion thereof proximate to the attaching flange 71. In contrast thereto, the displacement sensor 53 having a light weight is attached proximately to the front end of the main body 57, that is, a side thereof being remote from the attaching flange 71. By the constitution, growth of vibration transmitted from the transmission case 1a to the selecting case 51 is prevented in operation to prevent an error brought about in the detected value of the displacement sensor 53 and damage of the displacement sensor 53.

When the switch shaft 2a is displaced in the axial direction by the selecting actuator 8a, the pinion gear 52 is rotated in a predetermined direction based on electricity conduction to the selecting motor 9a. As a result, the output shaft 12a fixedly provided with the sector gear 56 brought in mesh with the pinion gear 52 is pivoted to pivot to displace the pivoting arm 13a. Further, the engaging projected portion 14a provided at the front end portion of the pivoting arm 13a displaces the switch shaft 2a in the axial direction. An amount of the displacement is detected by the displacement sensor 53 as the rotational angle of the output shaft 12a. By transmitting a detecting signal of the displacement sensor 53 to a controller for controlling electricity conduction to the selecting electric motor 9a, the switch shaft 2a can be displaced to a predetermined position in the axial direction.

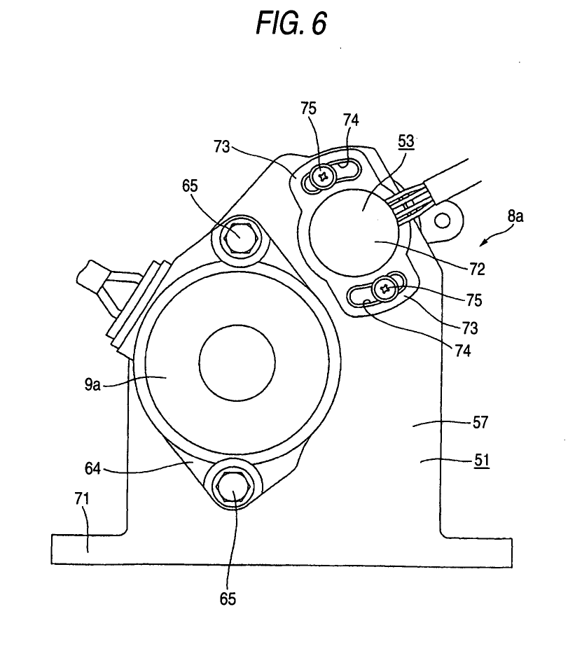

According to the embodiment, fine adjustment of a position of attaching the displacement sensor 53 relative to the main body 57 of the selecting case 51 is made to be able to carry out easily. That is, in the case of the example, in order to attach a holder 72 containing the displacement sensor 53 to the main body 57 of the selecting case 51, the holder 72 is provided with flange portions 73, 73 as shown by FIG. 6. Further, attaching screws 75, 75 inserted into through holes 74, 74 formed at the two flange portions 73, 73 are screwed to screw holes formed at the main body 57 to fasten. In the case of the embodiment, the respective through holes 74, 74 are long holes in a shape of a circular arc centering on a point on a center line of the output shaft 12a constituting the center of pivoting the pivoting arm 13a. By the constitution, a position of pivoting the pivoting arm 13a is made to be able to properly detect by easily carrying out fine adjustment of the position of attaching the displacement sensor 53 relative to the main body 57.

According to the embodiment, by making directions of attaching the selecting electric motor 9a and the displacement sensor 53 relative to the main body 57 the same as each other, the two members 9a and 53 are facilitated to integrate. That is, both of the selecting electric motor 9a and the displacement sensor 53 are integrated to the main body 57 from a left-side of FIG. 8. Therefore, the integrating operation can be facilitated by facilitating to arrange harnesses belonging to the selecting electric motor 9a and the displacement sensor 53 or the like.

Although according to the embodiment, the displacement sensor 53 of a contact type is used, as the displacement sensor 53, a noncontact type sensor of a proximity sensor or the like can also be used. When the noncontact type sensor is used, a problem of wearing a contact portion of the engaging projection 69 and the engaging recess portion 70 by vibration applied in operation can be restrained from being posed. As a detecting mechanism of the noncontact type sensor, various mechanisms which have been known in background arts of an optical type, an electromagnetic type, a type of using a hall IC and the like can be used. In this case, it is not necessary that the noncontact type sensor (similarly also in the case of the contact type) can detect the position in the all the range of vibration of the pivoting arm 13a. The sensor will do so far as positions necessary for carrying out selecting operation, that is, three portion positions of both end positions and a central position of pivoting can be detected.

Further, regardless of whether the displacement sensor 53 is of the contact type or the noncontact type, the displacement sensor 53 can also be constituted such that the detecting signal of the displacement sensor 53 is transmitted to the side of the controller by wireless communication. By transmitting the detecting signal by wireless, a harness belonging to the displacement sensor 53 can be omitted. Further, in this case, the displacement sensor 53 can include a battery, or power can also be supplied from the side of the selecting electric motor 9a in which a harness is indispensable. The selecting electric motor 9a and the displacement sensor 53 are contiguous to each other and therefore, it is easy to provide the harness for supplying power from the selecting electric motor 9a to the displacement sensor 53.

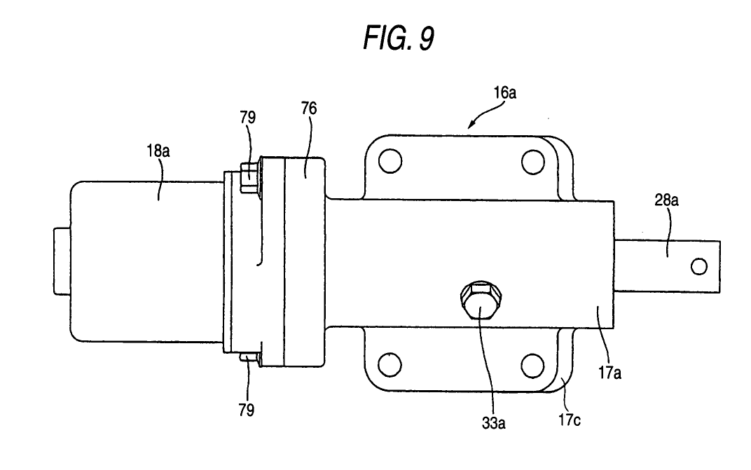

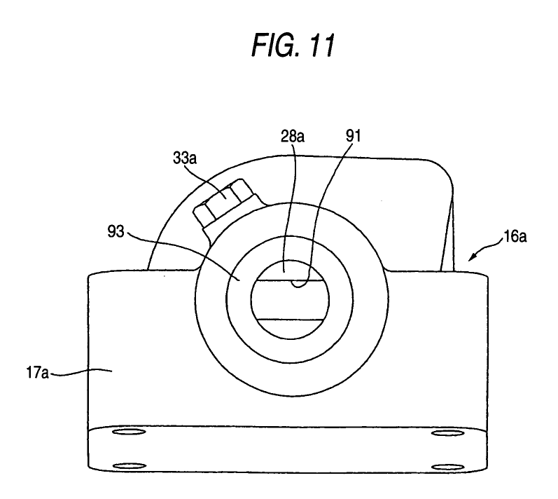

FIGS. 9 through 12 are views showing the shifting actuator 16a. According to the shifting actuator 16a, a shifting electric motor 18a capable of being rotated regularly and rotated reversely is fixedly supported by one end portion (left end portion of FIGS. 9, 10, 12) of a shifting case 17a made of a nonferrous metal of a light metal or the like such as an aluminum alloy and having substantially a cylindrical shape. According to the case of the embodiment, an outer diameter side fitting portion 76 in a shape of a stepped cylinder is provided at the one end portion of the shifting case 17a and an inner diameter side fitting portion 77 formed at a front end portion (right end portion of FIGS. 9, 10, 12) of the shifting electric motor 18a is inwardly fit to the outer diameter side fitting portion 76. An O ring 78 is mounted to a locking groove formed at an outer peripheral face of the inner diameter side fitting portion 77 and the O ring 87 is compressed elastically between a bottom portion of the locking groove and an inner peripheral face of the outer diameter side fitting portion 76. Under the state, coupling flanges formed at the outer peripheral face of the front end portion of the shifting electric motor 18a and formed at an outer peripheral face of the base end portion of the shifting case 17a are butted to each other to couple the two coupling flanges by coupling bolts 79, 79.

Further, when the shifting case 17a and the shifting electric motor 18a are integrated while pressing the O ring 78 to the outer diameter side fitting portion 76, pressure at inside of the shifting electric motor 18a is increased. In order to prevent a seal ring 93 provided between an inner peripheral face of a front end portion of the shifting case 17a and an outer peripheral face of an output member 28a, mentioned later, from being turned out by restraining such a pressure increase, a small hole for air vent can also be formed at a portion of the shifting case 17a. Such a hole is closed by a resin (adhering agent) after integration is finished. However, when the seal ring 93 is finally integrated, or the pressure increase is limited, such a consideration is not necessary.

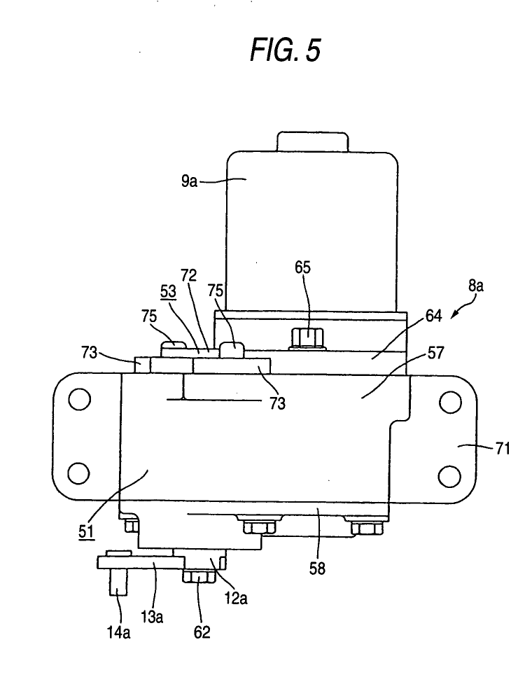

The O ring 78 prevents a foreign matter of rain water or the like from invading inside of the shifting case 17a and prevents grease sealed in the shifting case 17a from being leaked. The grease lubricates respective rolling contact portions provided in the shifting case 17a and lubricates sliding contact portion between an outer peripheral face of the output member 28a, mentioned later and an inner peripheral face of a sliding bearing 29. Also with regard to the grease lubricating the respective portions in this way, grease of the same kind is used for a total of the shifting actuator 16a to prevent a deterioration accompanied by mixing grease and achieves low cost formation by simplifying control and operation of filling the grease. Further, with regard to the shifting electric motor 18a, it is preferable to use the shifting electric motor 18a having a specification the same as that of the selecting electric motor 9a (FIGS. 5 through 8) (the same kind) in view of achieving a reduction in cost. That is, by making the specifications of the two motors 18a and 9a the same as each other, other than a reduction in cost by a mass production effect, the cost is reduced by making portions of control circuits common and a consideration or the like for preventing erroneous integration is dispensed with. Further, it is preferable in view of making small-sized formation of the two motors 18a and 9a and swift formation of gear change operation compatible with each other to use the two motors 18a and 9a driven by power source voltage higher than that of a battery for an automobile of a background art.

Further, a portion of a middle portion of a ball screw shaft 20a proximate to a base end thereof is supported to be able to only rotate by a rolling bearing 21 of a deep groove type ball bearing or the like (in a state of hampering displacement in a axial direction) at a portion of a middle portion on an inner side of the shifting case 17a proximate to the base end. Further, rotation of an output shaft 22 is made to be able to transmit to the ball screw shaft 20a by subjecting a portion of a base end portion of the ball screw shaft 20a projected from the rolling bearing 21 and the output shaft 22 of the shifting electric motor 18a to serration engagement (including spline engagement) similar to the above-described case of the selecting actuator 8a. Further, also with regard to male and female of the serration engagement in this case, the male and female may be reverse to that in the illustrated case. Further, male and female of the serration coupling in this case maybe reversed from that of the illustrated case. Further, the ball screw shaft 20a may be integrated to the output shaft 22 of the shifting electric motor 18a. By integrating the ball screw shaft 20a with the output shaft 22, operation of coupling the ball screw shaft 20a and the output shaft 22 can be omitted and coupling at the coupling portion can completely be eliminated.

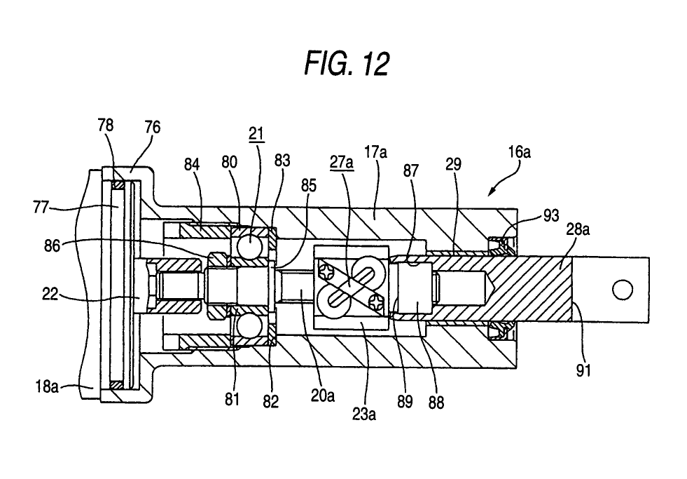

Further, in an outer ring 80 and an inner ring 81 of the rolling bear 21, in a state of being butted to a steppe portion 82 formed at the inner peripheral face of the shifting case 17a via an outer ring interposing seat 83, the outer ring 80 is pressed to the stepped portion 82 by a press nut 84 in a cylindrical shape to fix to the inner peripheral face of the shifting case 17a. Further, an inner diameter of the outer ring interposing seat 83 is made to be smaller than an outer diameter of a ball nut 23a to make the outer ring interposing seat 83 serve as a stopper. Meanwhile, the inner ring 81 is pinched between a stopper ring 85 (or a flange portion integral with the ball screw shaft 20a) locked by the outer peripheral face of the middle portion of the ball screw shaft 20a and a press nut 86 screwed to a male screw portion formed at the outer peripheral face of the base end portion of the ball screw shaft 20a to fix to the outer peripheral face of the ball screw shaft 20a. Further, in order to make the outer ring interposing seat 83 serve as a stopper, a face of two side faces of the stop ring 85 opposed to the ball nut 23a is recessed more than a face of two side faces of the outer ring interposing seat 83 opposed to the ball nut 23a in an axial direction (direction of FIG. 12).

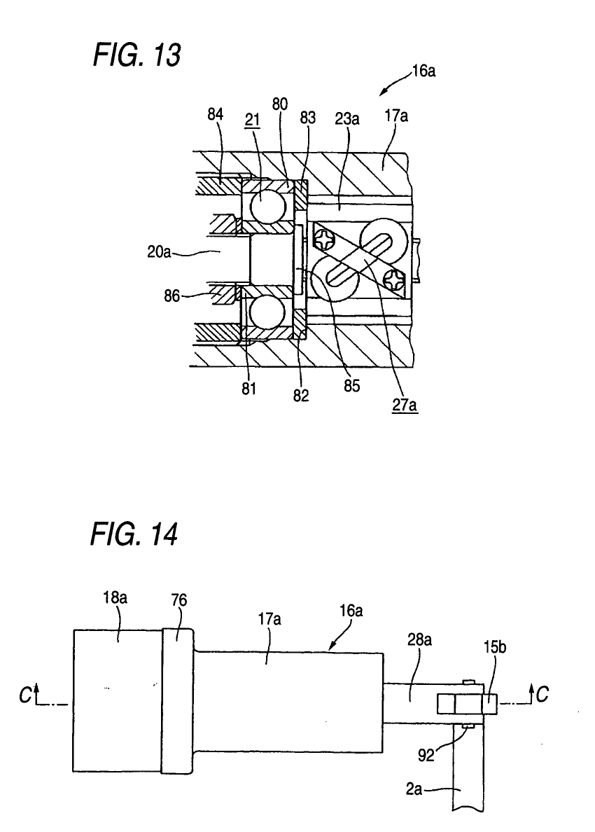

Therefore, when the ball nut 23a is moved in the left direction from the state of FIG. 12, as shown by FIG. 13, the end face of the ball nut 23a is butted to the outer ring interposing seat 83 and is not butted to the stop ring 85. The reason of constituting in this way is for preventing the end face in the axial direction of the ball nut 23a from being butted to a portion fixed to the ball screw shaft 20a to thereby prevent occurrence of operational failure accompanied by misalignment of a ball arranged between the ball nut 23a and the ball screw shaft 20a.

Further, a ball screw apparatus 27a is constituted by arranging the ball nut 23a at a surrounding of the ball screw shaft 20a and arranging a plurality of balls between a male ball screw groove formed at the outer peripheral face of the ball screw shaft 20a and a female ball screw groove formed at the inner peripheral face of the ball nut 23a. Further, all of the ball screw shaft 20a and the ball nut 23a and the respective balls are made by a ferrous metal of bearing steel or the like to prevent play accompanied a change in temperature of use from being brought about by reducing differences in thermal expansion amounts. Further, at least portions brought into rolling contact with each other are formed with layers hardened by a heat treatment to ensure rolling fatigue life of the portions. As the heat treatment which is carried out in this case, a pertinent heat treatment in accordance with a material is selected from quenching tempering, carbonizing, carbo-nitriding, high frequency heat treatment and the like. Further, it is preferable to constitute a surface hardness of the hardened layer by about HRc55 or higher and constitute a thickness thereof by about 0.1 through 1.5 mm. Further, with regard to the plurality of balls, balls made by ceramic of silicon nitride or the like can also be used. When the ball made of ceramic is used, occurrence of metal contact at rolling contact portion can firmly be prevented and even when a failure in lubrication is assumedly brought about, the failure can be made to be difficult to amount to other important damage of seizure or the like.

Further, although a method of working the male ball screw groove at the outer peripheral face of the ball screw shaft 2a and a method of working the female ball screw groove at the inner peripheral face of the ball nut 23a, various method which have been known in background arts of cutting and the like can be adopted, when the ball screw grooves are produced by plastic deformation, the screw grooves of high quality having excellent durability can be produced at low cost. As the plastic deformation used in this case, forming of rod is pertinent with regard to the male ball screw groove and cold forging is pertinent with regard to the female ball screw groove, respectively.

In any of the cases, it is preferable to provide a positive clearance of about 1 through 250 μm as a clearance in the axial direction in view of reducing consumption energy and promoting durability. That is, when the ball screw apparatus 27s is provided with a negative clearance (applied with prepressure), the consumption energy of the shifting electric motor 18a is increased. Further, by vibrating to displace the ball under no load state by vibration of about 200 through 300 Hz incessantly applied from the engine in operation, fretting wear is liable to be brought about at the respective ball screw grooves. In contrast thereto, when the clearance in the axial direction is constituted by a positive value of about 1 through 250 μm, not only the consumption energy of the shifting electric motor 18a can be reduced but also the fretting wear can be restrained. Further, when the value of the axial direction clearance is made to be equal to or larger than 300 μm, the fretting wear is liable to be brought about similarly.

The ball nut 23a is displaced in the axial direction of the ball screw shaft 20a in accordance with rotation of the ball screw shaft 20a since rotation of the ball nut 23a per se is hampered as mentioned later. Further, one end face (right end face of FIG. 12) of the ball nut 23a is coupled with a base end portion of the output member 28a in a shape of a circular cylinder. In the case of the embodiment, a large diameter portion 87 formed at an inner peripheral face of the base end portion of the output member 28a is outwardly fit to a coupling projected portion 88 in a shape of a circular cylinder projected at a central portion of a front end face (right end face of FIG. 12) of the ball nut 23a without play. Further, by calking a base end edge of the output member 28a to a locking groove 89 formed at the outer peripheral face of the base end portion of the coupling projected portion 88, the output member 28a and the ball nut 23a are coupled to fix. By the constitution, a structure capable of transmitting a thrust force in two directions between the output member 28a and the ball nut 23a without play is realized at the low cost. Further, a base half portion (left half portion of FIG. 12) of the output member 28a is constituted by a shape of a hollow circular cylinder to prevent interference with the ball screw shaft 20a. By the constitution, a necessary stroke is ensured while preventing a length in the axial direction of the ball nut 23a from being prolonged more than necessary.

Further, it is preferable to constitute the output member 28a by a material in consideration of rust prevention since the output member 28a is exposed to outside air when used. For that purpose, a total of the output member 28a is made of stainless steel, or at least a portion of the outer peripheral face of the output member 28a exposed from the shifting case 17a when used is formed with a corrosion preventing skin film of a plating layer, a resin skin film or the like. By the constitution, the outer peripheral face of the output member 28a is prevented from being corroded and the sliding resistance between the outer peripheral face of the output member 28a and an inner peripheral face of the sliding bearing 29, mentioned later is prevented from being increased base on corrosion.

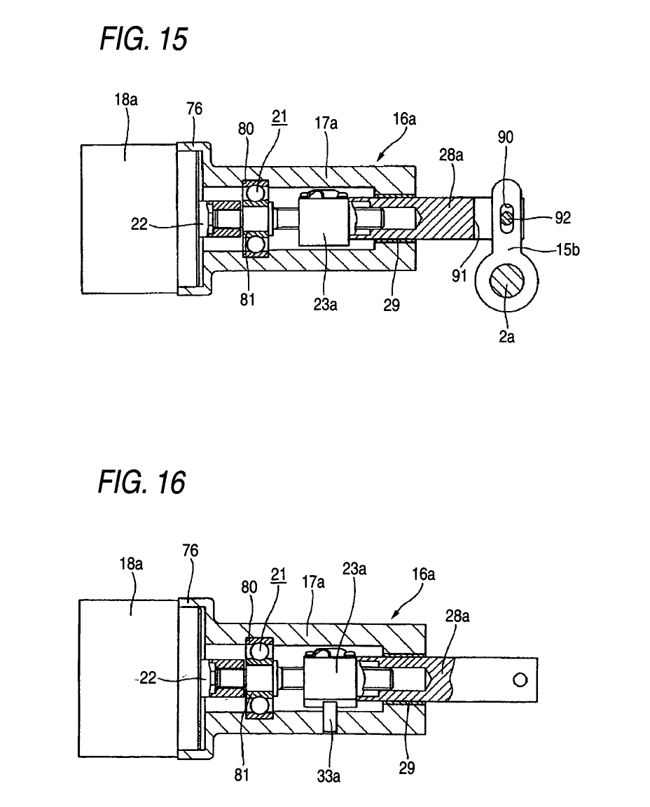

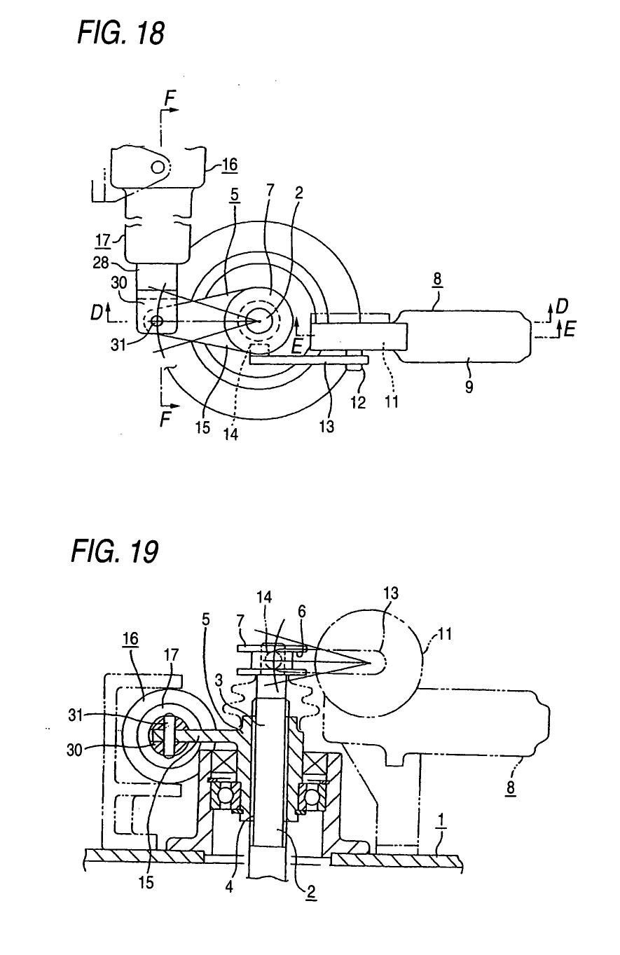

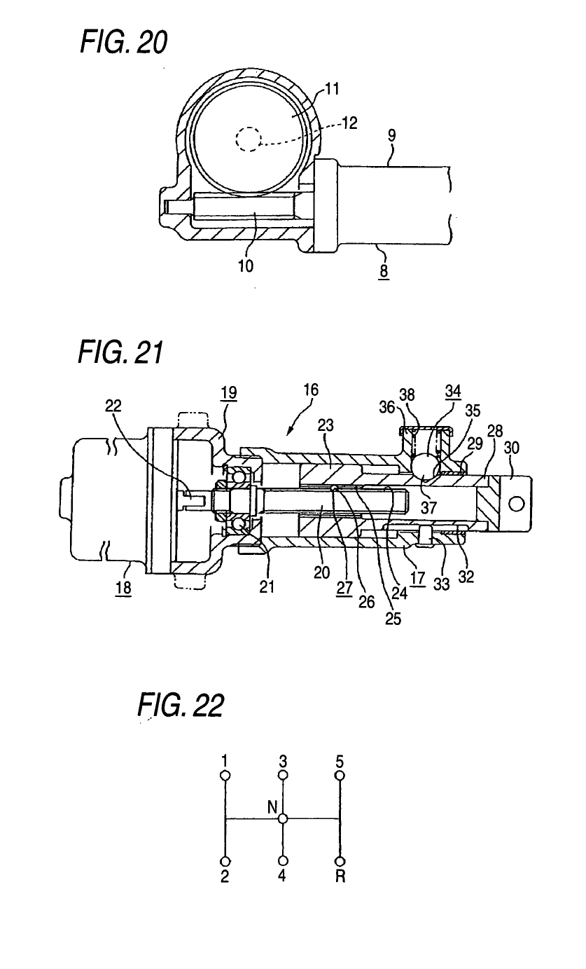

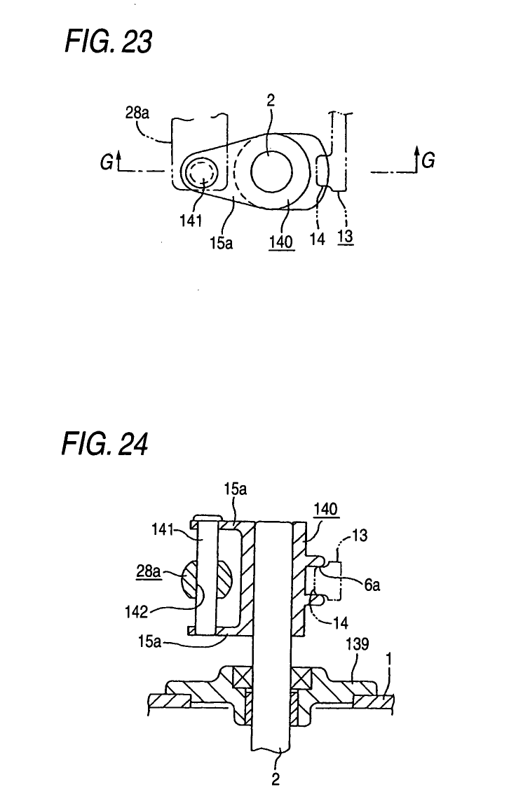

The outer peripheral face of the middle portion of the output member 28a is brought into sliding contact with the sliding bearing 29 locked by the inner peripheral face of the front end portion (right end portion of FIGS. 9, 10, 12) of the shifting case 17a. A dimension in the axial direction of the sliding bearing 29 is sufficiently ensured to ensure a rigidity against a moment load applied to the output member 28a. Further, the front end portion of the output member 28a is formed by a bifurcated shape to couple to the middle portion of a driving arm 16b engaged by a spline with the end portion of the switch shaft 2a as shown by FIGS. 14 through 16. That is, a middle portion of the driving arm 16b is formed with a long hole 90 prolonged in the diameter direction of the switch shaft 2a and the middle portion is inserted into a recess portion 91 formed at a front end face of the output member 28a in a diameter direction. Further, a pin 92 fixed to the front end portion of the output member 28a is engaged with the long hole 90 in a state of traversing the recess portion 91. By constituting the electric driving apparatus for a transmission of the example in this way, the switch shaft 2a is made to be able to pivot to displace in a state of fixing the shifting case 17a to the outer face of the transmission case 1a.

Here, the shifting case 17a is provided with a flange 17c for attaching to the transmission case 1a. A contact fact 17d of the attaching flange 17c in contact with the transmission case 1a is made to be unparallel with a center axis of the output member 28a, that is, a center axis of the shifting actuator 16a and the shifting electric motor 18a is attached to be remote from the transmission case 1a. Therefore, also in the embodiment, similar to the first embodiment, a diameter of the shifting electric motor 18a can be made to be larger than twice of a distance between the outer face of the transmission case 1a and the center of the spline cylinder (distance from an axis center of the output shaft member 28a to the outer face of the transmission case 1a at an axis center portion of the switch shaft) L₅ (D₁₈>2 L₅)

Further, as described above, the shifting case 17 is made by a nonferrous metal of an aluminum alloy or the like and is produced by a material of a species the same as that of the transmission case 1a. Therefore, light-weighted formation of the shifting case 17a is achieved and occurrence of rattling accompanied by a change in a temperature of use is prevented by reducing a difference between thermal expansion coefficients of the shifting case 17a and the transmission case 1a.

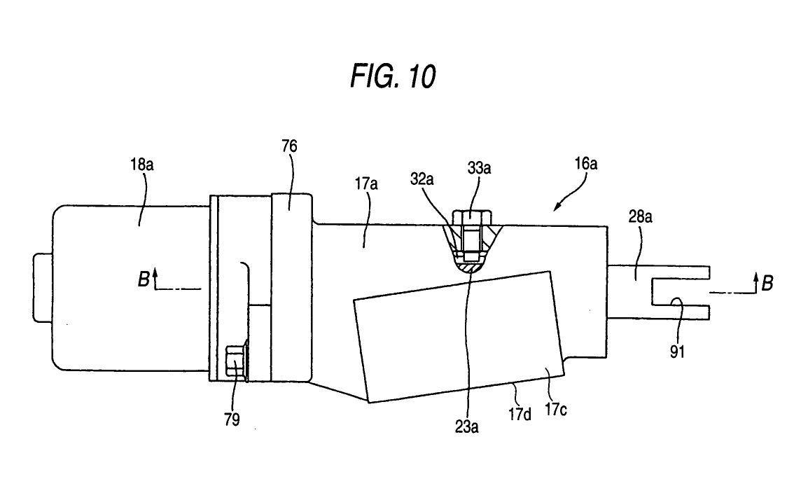

Further, in the case of the example, as shown by FIG. 10, the output member 28a and the ball nut 23a are prevented from being rotated by engaging a guide pin 33a fixed to the front end portion of the shifting case 17a to a guide groove 32a formed at the outer peripheral face of the ball nut 23a in the axial direction. However, it is not necessarily needed to provide such a detent structure by the guide groove 32a and the guide pin 33a. That is, in the case of the example, as described above, the output member 28a and the ball nut 23a fixed with the output member 28a are prevented from being rotated based on engagement between the driving arm 15a and the recess portion 91. Therefore, the detent structure by the guide groove 32a and the guide pin 33a may be omitted. Further, even when the detent structure by the guide pin is provided, the detent structure is not limited to the structure of fixing the guide pin 33a to the shifting case 17a by stopping by screw as shown by FIG. 10 but as shown by FIG. 16, a structure of simply fitting to fix a guide pin 33b in a shape of a circular cylinder to the shifting case 17a can also be adopted.

As described above, the electric driving apparatus according to the embodiment changes gears of the gear change unit included in the transmission case 1a as follows. First, the pivoting arm 13a is pivoted to displace in an up and down direction of FIGS. 3, 4, 8 by rotating the selecting electric motor 9a constituting the selecting actuator 8a in a predetermined direction. Further, selecting operation is carried out by displacing the switch shaft 2a in the axial direction in a predetermined direction via the locking claw 7 by the engaging projected portion 14a provided at the front end portion of the locking arm 13a. In this case, a position of the switch shaft 2a in the axial direction is detected by the displacement sensor 53.

After carrying out the selecting operation in this way, the switch shaft 2a is rotated in a predetermined direction via the driving arm 15b by extracting and retracting the shifting actuator 16a in order to carry out shifting operation. In carrying out shifting operation in this way, the ball screw shaft 20a is rotated in a predetermined direction by the shifting electric motor 18a. Further, the ball nut 23a and the output member 28a are displaced in the axial direction by the ball screw apparatus 27a to push and pull the driving arm 15b.

At this occasion, the shifting actuator 16a is displaced from a neutral state in correspondence with the state of neutral (a state of middle of the length dimension) to a fully elongated state or a fully contracted state. Gear change operation for successively carrying out the selecting operation and the shifting operation in this way are carried out by an electric control from a controller while relating the displacement in the selecting direction (X direction) and the displacement in the shifting direction (Y direction).

Next, FIG. 17 shows a modified example of the second embodiment of the invention. In the case of the example, a selecting case 51a for containing the selecting actuator 8a and a shifting case 17b for containing the shifting actuator 16a are integrally formed. Further, by coupling an attaching flange 71a common to the two cases 51a and 17b to the outer face of the transmission case 1a (FIG. 3), the two actuators 8a and 6a are made to be able to fix to the outer face. In the case of the example, by adopting such a constitution, a space of attaching the two actuators 8a and 16a is made to be able to reduce and attaching operation is facilitated.

Further, although in the above-described respective examples, as the shifting actuator, there is shown the structure of rotating the ball screw shaft without moving the ball screw shaft in the axial direction and moving the ball nut in the axial direction without rotating the ball nut, the ball screw apparatus constituting the shifting actuator constituting the electric driving apparatus for a transmission of the invention is not limited to such a structure but following three kinds of structure can also be adopted. A first structure is a structure of engaging a ball screw shaft to a ball nut which is not rotated and moved in an axial direction to be able to rotate and move in the axial direction. A second structure is a structure of engaging a ball screw shaft to a ball nut which is only rotated and is not moved in the axial direction movably in the axial direction in a state of being hampered to rotate. A third structure is a structure of engaging a ball nut to a ball screw shaft which is not rotated and moved in the axial direction to be able to rotate and move in the axial direction.

Although an explanation has been given of the invention in details and in reference to the specific embodiments as described above, it is apparent for a skilled person that the invention can variously be changed or modified without deviating from the spirit and the range of the invention.

The application is based on Japanese Patent Application (Japanese Patent Application No. 2002-016500) filed on Jan. 25, 2002 and Japanese Patent Application (Japanese Patent Application No. 2002-028542) filed on Feb. 5, 2002 and contents thereof are incorporated here by reference.

### Industrial Applicability

According to the invention, the electric type actuator capable of swiftly and firmly carrying out shift operation can be provided. Therefore, when the electric type actuator is applied to, for example, the electric driving apparatus for a transmission, a strange feeling given to a driver in gear change can be reduced or resolved by realizing swift gear change operation.

1. An electric type actuator fixed to an outer face of a case containing a driven portion at inside thereof for driving a transmitting member projected from the outer face for driving the driven portion, the electric type actuator comprising:
an electric motor; and
an output member for transmitting a displacement based on rotation of the electric motor to the transmitting member, wherein
a radius of the electric motor is larger than a distance from an axis center of the output member disposed at an axis center portion of the transmitting member to the outer face of the case.

2. The electric type actuator according to claim 1, wherein
the outer face of the case of provided with a recess portion and a portion of a housing of the electric motor is made to advance into the recess portion.

3. The electric type actuator according to claim 1, wherein
the outer face of the case is an inclined face formed with a portion of projecting the transmitting member and a portion of attaching a housing of the electric motor continuously to each other.

4. The electric type actuator according to any one of claims 1 through 3, further comprising:
an actuator case,
a ball screw shaft provided at inside of the actuator case,
a ball nut reciprocated along the ball crew shaft, and
an inner peripheral face of the actuator case provided with a stopper for preventing an end face in an axial direction of the ball nut from being butted to a portion fixed to the ball screw shaft.
